(19) United States
(12) Patent Application Publication
(10) Pub. No.: US 2006/0230599 A1
(43) Pub. Date: Oct. 19, 2006

(54) Clamp ring detaching method, clamp ring detaching tool, and method of manufacturing magnetic disk device

(75) Inventors: Kazuhiko Mori, Tokyo (JP); Fujio Takahashi, Yokohama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/367,329

(22) Filed: Mar. 6, 2006

(30) Foreign Application Priority Data
Apr. 18, 2005 (JP) 2005-119852

(51) Int. Cl. G11B 5/127; B23P 19/00

(52) U.S. Cl. 29/603.03; 29/762; 29/426.5

(57) ABSTRACT

A clamp ring detaching method of detaching from a motor hub a clamp ring fastened to the motor hub, the clamp ring comprising a plurality of hub pressing portions contacting the outer circumferential surface of the motor hub and connecting portions which connect the hub pressing portions, each connecting portion having a concave portion, the method including pressing portions of at least one of the concave portions, which are displaced from a center of the concave portion, outwards in a radial direction of the clamp ring in order to remove the clamp ring from the motor hub.

### CROSS-REFERENCE TO RELATED APPLICATIONS

This application is based upon and claims the benefit of priority from prior Japanese Patent Application No. 2005-119852, filed Apr. 18, 2005, the entire contents of which are incorporated herein by reference.

### BACKGROUND OF THE INVENTION

1. Field of the Invention

The present invention relates to a method of detaching a clamp ring that is fixed to a motor hub of, for example, a magnetic disk device by means of shrink fitting; a tool for detaching such a clamp ring; and a method for manufacturing a magnetic disk device.

2. Description of the Related Art

There is known a magnetic disk device in which a medium is turned and information is read from and written to a recording surface of the medium. In recent years, the magnetic disk device has been made into such a compact size (for example, around 0.85 inches) as to be loaded on a mobile device such as a cellular phone.

FIG. 12 is a cross-sectional view of a 0.85-inch magnetic disk device.

As shown in FIG. 12, the 0.85-inch magnetic disk device includes a part called a motor hub 200, which is fixed to a rotator of a motor. The motor hub 200 rotates as a rotating shaft of the motor, and a disk-shaped medium 201 is fixed to the outer circumference thereof.

A clamp ring 202 is used for fixing the medium 201. The clamp ring 202 is attached to the motor hub 200, and presses the medium 201 onto a support portion 200a of the motor hub 200 to prevent the medium 201 from rotating or moving on the motor hub 200.

Meanwhile, in the manufacture of a magnetic disk device, the magnetic disk device is in some cases disassembled and reassembled according to evaluation results of functions and operations after assembly. For this reason, it is desired for the method of fixing the medium 201 that the medium 201 can be detached from the motor hub 200.

Accordingly, two kinds of fixing method currently proposed by those skilled in the art are introduced in FIGS. 13 and 14.

FIG. 13 is a view showing a configuration of a magnetic disk device in which the clamp ring 202 has been attached by a thread fastening method.

As shown in FIG. 13, the medium 201 in the magnetic disk device is fixed onto the motor hub 200 by the clamp ring 202 that is screwed to the motor hub 200. Accordingly, thread grooves 203 are formed on the outer circumference of the motor hub 200 and the inner circumference of the clamp ring 202, respectively. In the case of the thread fastening method, the clamp ring 202 can be detached from the motor hub 200 only by loosening screws.

FIG. 14 is a view showing a configuration of a magnetic disk device in which the clamp ring 202 has been attached by a shrink fitting method.

As shown in FIG. 14, the medium 201 in the magnetic disk device is fixed onto the motor hub 200 by the clamp ring 202 that is shrink-fitted to the motor hub 200. Meanwhile, the inner diameter of the clamp ring 202 used herein at a room temperature is smaller than the outer diameter of the motor hub 200.

In the case when the clamp ring 202 is shrink-fitted to the motor hub 200, the clamp ring 202 is first heated and expanded. At the moment when the inner diameter of the clamp ring 202 becomes larger than the outer diameter of the motor hub 200, the clamp ring 202 is mounted on the motor hub 200. Then, the clamp ring 202 is naturally or forcibly made back to a room temperature. Thereby, the clamp ring 202 shrinks, and gets in a state of being fastened to the motor hub 200. In the case of the shrink fitting method, the clamp ring 202 can be detached from the motor hub 200 only by expanding the inner diameter of the clamp ring 202 (for example, refer to Jpn. Pat. Appln. KOKAI Publication No. 8-297910).

However, the 0.85-inch magnetic disk device has a problem that the structure thereof is limited by its narrow internal space, so that the thread fastening method cannot be applied thereto. Therefore, the only way is to use the shrink fitting method for the 0.85-inch magnetic disk device. However, the clamp ring fixed by the shrink fitting method has a problem that it is more difficult to detach the clamp ring than in the thread fastening method.

### BRIEF SUMMARY OF THE INVENTION

Accordingly, an aspect of the present invention is to provide a clamp ring detaching method, a clamp ring detaching tool, and a method of manufacturing a magnetic disk device, for enabling to easily detach a clamp ring fixed by a fitting method that prevents relative movement.

The clamp ring detaching method, the clamp ring detaching tool, and the method of manufacturing a magnetic disk device according to the present invention are configured as described below for example,

(1) A clamp ring detaching method of detaching from a motor hub a clamp ring fastened to the motor hub, the clamp ring comprising a plurality of hub pressing portions contacting the outer circumferential surface of the motor hub and connecting portions which connect the hub pressing portions, each connecting portion having a concave portion, the method comprising: pressing portions of at least one of the concave portions, which are displaced from a center of the concave portion, outwards in a radial direction of the clamp ring in order to remove the clamp ring from the motor hub.

(2) A clamp ring detaching tool to be used when detaching from a motor hub a clamp ring fastened to the motor hub, the clamp ring comprising a plurality of hub pressing portions contacting the outer circumferential surface of the motor hub and connecting portions which connect the hub pressing portions, each connecting portion having a concave portion, the tool comprising: a pressing portion which presses those portions of at least one of the concave portions which are displaced from a center of the concave portion, at the same time outwards in a radial direction of the clamp ring.

(3) A method of manufacturing a magnetic disk device, having detaching from a motor hub a clamp ring fastened to the motor hub, the clamp ring comprising a plurality of hub pressing portions contacting the outer circumferential surface of the motor hub and connecting portions which connect the hub pressing portions, each connecting portion having a concave portion, the detaching comprising: pressing portions of at least one of the concave portions, which are displaced from a center of the concave portion, outwards in a radial direction of the clamp ring in order to remove the clamp ring from the motor hub.

According to the invention, a clamp ring fixed to a motor hub can be easily detached.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a cross-sectional view of a magnetic disk device according to a first embodiment of the present invention;

FIG. 2 is a cross-sectional view of a motor hub according to the first embodiment;

FIG. 3 is a plan view of a clamp ring according to the first embodiment;

FIG. 4 is a configuration diagram of an attaching/detaching device according to the first embodiment;

FIG. 5A is a front view of a heater head and attaching/detaching heads according to the first embodiment;

FIG. 5B is a plan view of the heater head and the attaching/detaching heads according to the first embodiment;

FIG. 6 is a cross-sectional view of an attaching/detaching pin according to the first embodiment;

FIG. 7A is a view showing a stress applied to the clamp ring when the clamp ring is detached by use of the attaching/detaching pins according to the first embodiment;

FIG. 7B is a view showing a stress applied to the clamp ring when the clamp ring is detached by use of the attaching/detaching pins according to the first embodiment;

FIG. 7C is a view showing a stress applied to the clamp ring when the clamp ring is detached by use of the attaching/detaching pins according to the first embodiment;

FIG. 8A is a view showing a stress applied to the clamp ring when the clamp ring is detached by use of cylindrical attaching/detaching pins;

FIG. 8B is a view showing a stress applied to the clamp ring when the clamp ring is detached by use of the cylindrical attaching/detaching pins;

FIG. 8C is a view showing a stress applied to the clamp ring when the clamp ring is detached by use of the cylindrical attaching/detaching pins;

FIG. 9A is a process chart in case of detaching the clamp ring by a detaching method according to a second embodiment of the present invention;

FIG. 9B is a process chart in case of detaching the clamp ring by the detaching method according to the second embodiment;

FIG. 9C is a process chart in case of detaching the clamp ring by the detaching method according to the second embodiment;

FIG. 10 is a plan view of a clamp ring according to a third embodiment of the present invention;

FIG. 11A is a process chart in case of detaching the clamp ring by a detaching method according to the third embodiment;

FIG. 11B is a process chart in case of detaching the clamp ring by the detaching method according to the third embodiment;

FIG. 11C is a process chart in case of detaching the clamp ring by the detaching method according to the third embodiment;

FIG. 12 is a cross-sectional view of a 0.85-inch magnetic disk device;

FIG. 13 is a configuration view of a magnetic disk device in which a clamp ring has been attached by a thread fastening method; and

FIG. 14 is a configuration view of a magnetic disk device in which a clamp ring has been attached by a shrink fitting method.

### DETAILED DESCRIPTION OF THE INVENTION

First to third embodiments of the present invention will be illustrated in more details with reference to the accompanying drawings hereinafter.

(First Embodiment)

First, a first embodiment will be explained hereinafter.

[Configuration of Magnetic Disk Device 1]

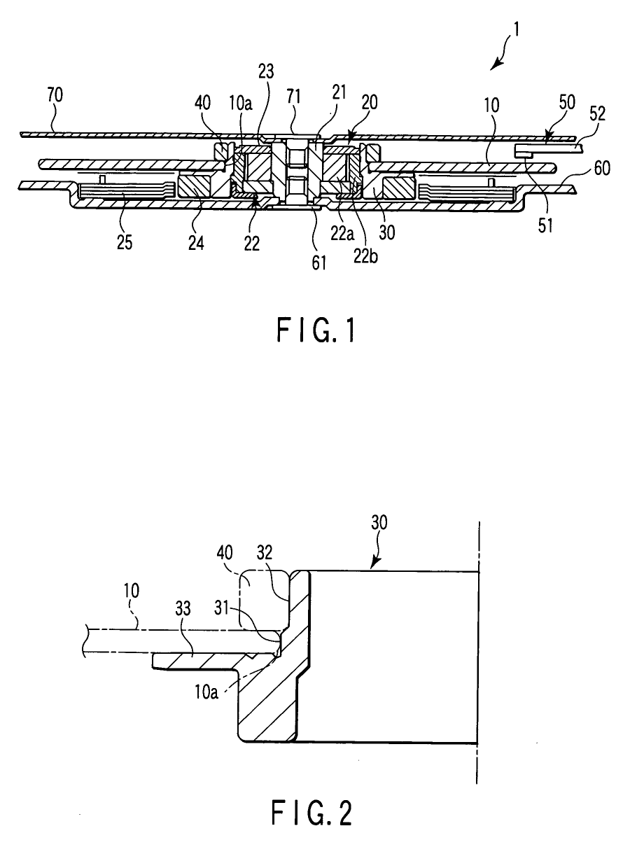

FIG. 1 is a cross-sectional view of a magnetic disk device 1 according to the first embodiment of the invention.

As shown in FIG. 1, the magnetic disk device 1 includes: a medium 10 serving as a recording medium; a spindle motor 20 to turn the medium 10; a motor hub 30 serving as a rotating shaft of the spindle motor 20; a clamp ring 40 to fix the medium 10 to the motor hub 30; a magnetic head 50 to read and write information from and into the medium 10; a base 60 to which the spindle motor 20 is assembled; and a cover 70 to cover the medium 10, the spindle motor 20, the motor hub 30, the clamp ring 40, and the magnetic head 50.

The medium 10 is of a disk shape, and an attachment hole 10a for inserting the motor hub 30 therein is provided on a radial central portion of the medium. As the medium 10, a magnetic disk such as a hard disk is used.

The spindle motor 20 is configured by a fixed shaft 21, a fluid dynamic bearing 22, a bearing seal 23, a permanent magnet 24, and a stator 25, and the spindle motor generates a turning force around the fixed shaft 21 in the permanent magnet 24.

The fixed shaft 21 is of a cylindrical shape, and has the base 60 fixed with a screw 61 to one end surface thereof and has the cover 70 fixed with a screw 71 to the other end surface thereof. The fluid dynamic bearing 22 is configured by an inner ring 22a to be mounted on the outer circumferential surface of the fixed shaft 21, and an outer ring 22b arranged rotatably on the outer circumferential surface of the inner ring 22a. The bearing seal 23 is provided on an end surface of the fluid dynamic bearing 22 at the side of the cover 70. The permanent magnet 24 is fixed onto the outer circumference of the motor hub 30. The stator 25 is arranged at the outer circumferential side of the permanent magnet 24.

The motor hub 30 is of a substantially cylindrical shape, and is mounted on the outer circumferential surface of the outer ring 22b of the fluid dynamic bearing 22. Thereby, when the spindle motor 20 is actuated, the motor hub 30 rotates around the fixed shaft 21 by the turning force generated in the permanent magnet 24.

FIG. 2 is a cross-sectional view of the motor hub 30 according to the first embodiment.

As shown in FIG. 2, the motor hub 30 has, on the outer circumferential surface thereof, an attachment portion 31 for attaching the medium 10 thereto, a clamped portion 32 for mounting the clamp ring 40 thereon (the outer circumferential surface of the motor hub 30), and a support portion 33 for supporting the medium 10.

Meanwhile, the width of the attachment portion 31 is slightly smaller than the thickness of the medium 10. Consequently, when the clamp ring 40 is mounted on the clamped portion 32, the end surface of the clamp ring 40 presses the medium 10.

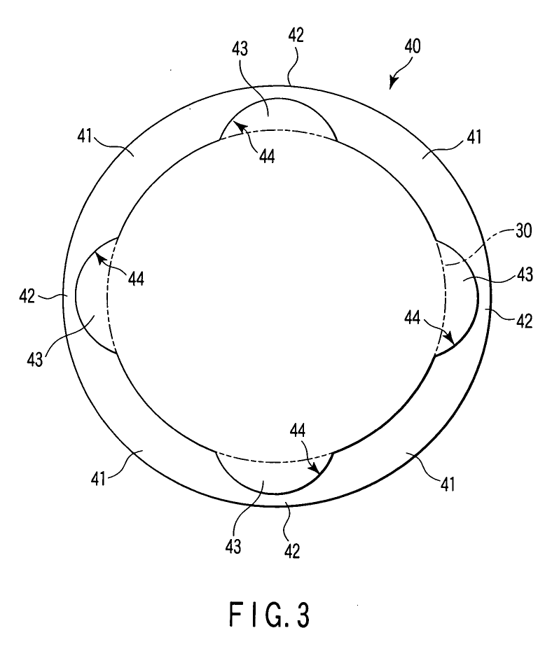

FIG. 3 is a plan view of the clamp ring 40 according to the first embodiment.

As shown in FIG. 3, the clamp ring 40 is mounted on the motor hub 30 by shrink fitting, and presses the media 10 to the support portion 33 of the motor hub 30. The clamp ring 40 includes; four hub pressing portions 41 that contact the clamped portion 32 of the motor hub 30 and four connecting portions 42 that connect the hub pressing portions 41 adjacent in the circumferential direction of the clamp ring 40. Each connecting portion 42 has a concave portion 44 that form an empty space 43 between the clamp ring 40 and the outer circumferential surface of the motor hub 30.

In the present embodiment the clamp ring 40 is composed of four hub pressing portions 41 and four connecting portions 42. The numbers of the hub pressing portions 41 and the numbers of the connecting portions 42 are not limited to four.

The inner circumferential surface of the hub pressing portions 41 is made of a part of a cylindrical surface. The inner diameter of the hub pressing portions 41 is formed smaller than the outer diameter of the motor hub 30 at a room temperature such that the hub pressing portions can be shrink-fitted to the motor hub 30.

The inner circumferential surface of the connecting portions 42 is made of a part of a cylindrical surface smaller than the inner circumferential surface of the hub pressing portions 41. Thereby, the connecting portions 42 are thinner than the hub pressing portions 41. Note that the shape of the connecting portions 42 is not limited to a cylindrical surface so far as it is a smooth curved shape not so as to be subject to stress concentration.

As shown in FIG. 1, the magnetic head 50 is configured by a head main body 51 that reads and writes information from and into the medium 10, and a swing arm 52 that swings the head main body 51 on the medium 10.

[Configuration of Attaching/Detaching Device 100]

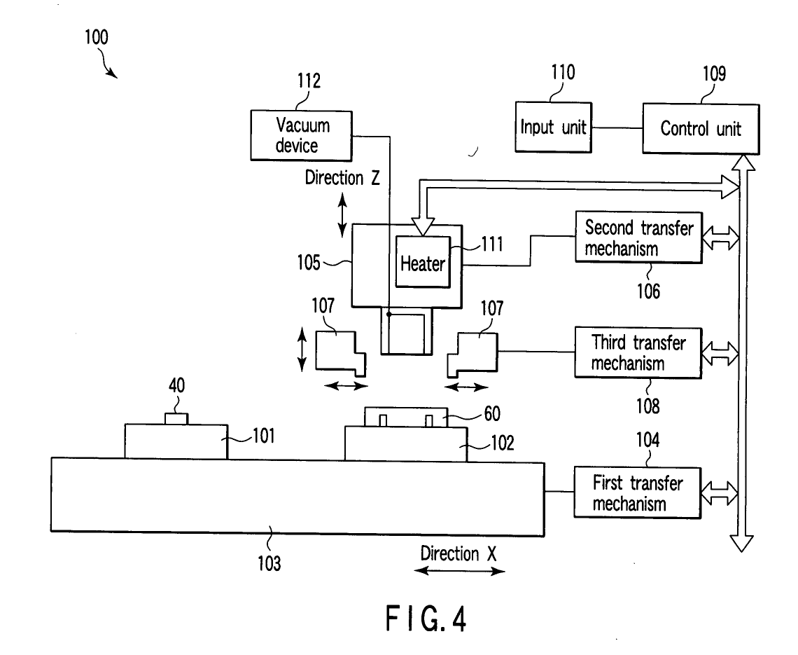

FIG. 4 is a configuration diagram of an attaching/detaching device 100 according to the first embodiment.

As shown in FIG. 4, the attaching/detaching device (detaching device) 100 includes a first positioning platform 101, a second positioning platform 102, a bed 103, a first transfer mechanism 104, a heater head 105, a second transfer mechanism 106, four attaching/detaching heads 107 (only two illustrated), a third transfer mechanism 108, a control unit 109, and an input unit 110. The first positioning platform 101 positions the clamp ring 40, and the second positioning platform 102 positions the base 60 having the spindle motor 20 assembled therein. The bed 103 supports the first and second positioning platforms 101, 102. The first transfer mechanism 104 transfers the bed 103 in a horizontal direction (direction X in the figure). The heater head 105 receives the clamp ring 40 from the first positioning platform 101 and heats the clamping ring 40. The second transfer mechanism 106 transfers the heater head 105 in a vertical direction (direction Z in the figure). The attaching/detaching heads 107 attach and detach the clamp ring 40 to and from the motor hub 30 assembled in the spindle motor 20 of the base 60 positioned by the second positioning platform 102. The third transfer mechanism 108 transfers the attaching/detaching heads 107 in the horizontal and vertical directions. The control unit 109 controls the first, second, third transfer mechanisms 104, 106, 108. The input unit 110 is provided for inputting instructions from an operator to the control unit 109.

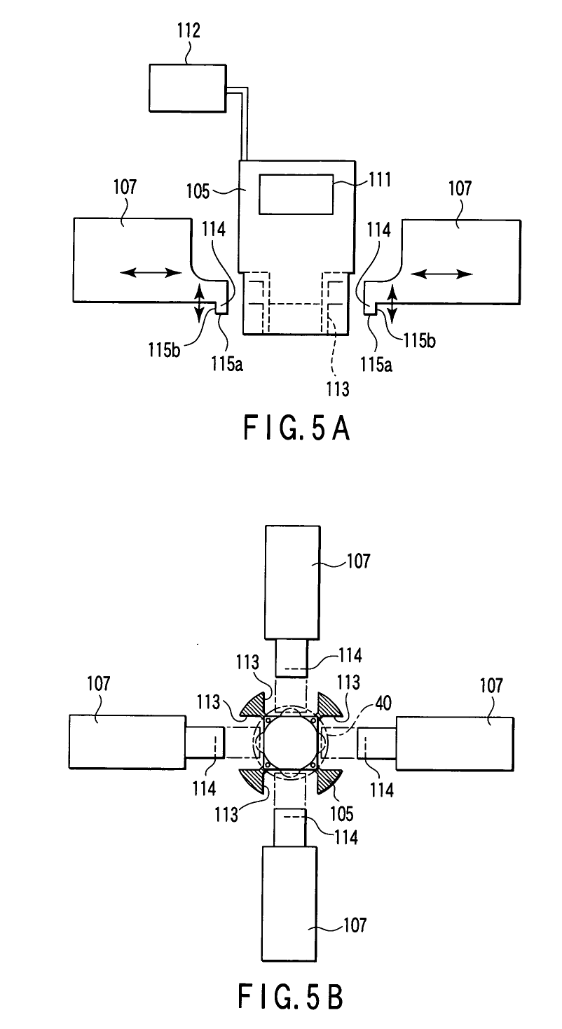

FIG. 5A is a front view of the heater head 105 and the attaching/detaching heads 107 according to the first embodiment, and FIG. 5B is a plan view of the heater head 105 and the attaching/detaching heads 107 according to the first embodiment.

As shown in FIGS. 5A and 5B, the heater head 105 includes a heater 111 and a vacuum device 112. The heater 111 heats the clamp ring 40 received from the first positioning platform 101 up to a shrink fitting temperature. The vacuum device 112 generates an absorbing force for absorbing and holding the clamp ring 40 to the under surface of the heater head 105 through a plurality of absorbing holes (not shown) formed in the heater head 105.

As a consequence, the heater head 105 receives the clamp ring 40 from the first positioning platform 101, heats the clamping ring 40 up to the shrink fitting temperature, and supplies the heated clamping ring to the motor hub 30 on the base 60 positioned by the second positioning platform 102.

On the outer circumferential surface of the heater head 105, groove portions 113 are arranged at an interval of 90 degrees along the horizontal direction. Parts of the clamp ring 40 absorbed and held by the heater head 105 are exposed from the respective groove portions 113.

The attaching/detaching heads 107 are arranged at an interval of 90 degrees at the same height, and have a configuration such that the third transfer mechanism 108 moves the attaching/detaching heads close to and away from the shaft center of the spindle motor 20 positioned by the second positioning platform 102.

In the end portions of the detaching/detaching heads 107, there are arranged substantially vertically attaching/detaching pins 114 for adding a pressing force to the clamp ring 40 when attaching and detaching the clamp ring 40 to and from the motor hub 30.

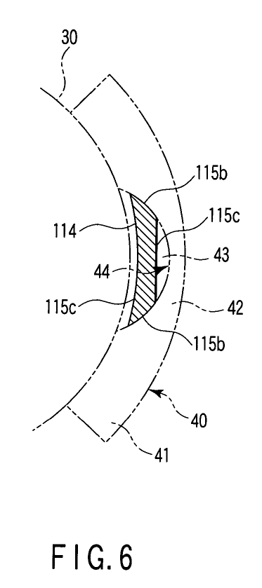

FIG. 6 is a cross-sectional view of the attaching/detaching pin 114 according to the first embodiment.

As shown in FIG. 6, the attaching/detaching pin (detaching tool) 114 is of a substantially trapezoidal cross section as a whole, which has substantially the same curvature radius as that of the connecting portions 42 of the clamp ring 40. On the lower ends of the attaching/detaching pins 114, plane-shaped first pressing surfaces (pressing surfaces) 115a (illustrated in only FIG. 5A) are formed. On both the end portions of the attaching/detaching pins 114 in the circumferential direction of the clamp ring 40, there are formed second pressing surfaces (pressing surfaces) 115b having substantially the same radius of curvature as that of the inner circumferential surface of the connecting portions 42 of the clamp ring 40. Further, on the radial inside and the radial outer side of the clamp ring 40 in the attaching/detaching pins 114, a surface 115c which connects the second pressing surfaces 115b is formed, the surface 115c having a larger radius of curvature than the second pressing surfaces 115b. Meanwhile, the surface 115c may be a plane surface.

The first pressing surfaces 115a press down the clamp ring 40 exposed from the groove portions 113 of the heater head 105 when the clamp ring 40 is attached to the motor hub 30. The second pressing surfaces 115b press the inner circumferential surface of the concave portions 44 of the connecting portions 42 of the clamp ring 40 to the radial outer side when the clamp ring 40 is detached from the motor hub 30.

[Method of Manufacturing Magnetic Disk Device 1]

The spindle motor 20 having the motor hub 30 is assembled into the base 60, and the medium 10 is mounted on the support portion 33 of the motor hub 30. Thereby, the motor hub 30 is inserted into the attachment hole 10a of the medium 10, and the clamped portion 32 protrudes from the attachment hole 10a to the opposite side of the base 60.

Then, the clamp ring 40 is attached to the clamped portion 32 protruding from the attachment hole 10a of the medium 10, and further the magnetic head 50 is assembled, so that the cover 70 is finally attached. The following method of attaching the clamp ring 40 and method of detaching the clamp ring 40 are part of the processes in the method of manufacturing the magnetic disk device 1.

[Method of Attaching Clamp Ring 40]

A method of attaching the clamp ring 40 in the case where the clamp ring 40 is attached to the clamped portion 32 of the motor hub 30 by the shrink fitting method will be explained hereinafter.

When the clamp ring 40 is to be attached to the motor hub 30, the clamp ring 40 is first supplied onto the first positioning platform 101, wherein the clamp ring 40 is positioned. Further, as another process, the base 60 to which the spindle motor 20 having the motor hub 30 has been assembled is supplied onto the second positioning platform 102, wherein the base 60 is positioned.

Next, the bed 103 is moved by the first transfer mechanism 104, and the first positioning platform 101 is set to a processing position. The processing position is the position where the clamp ring 40 is attached to and detached from the motor hub 30.

Then, the heater head 105 is lowered by the second transfer mechanism 106, and the clamp ring 40 positioned on the first positioning platform 101 is absorbed and held to the under surface of the heater head 105 by the vacuum device 112.

Next, the heater head 105 is moved upward, and at the same time, the clamp ring 40 is heated. Note that the heater head 105 is heated by the heater 111 before the heater head 105 absorbs and holds the clamp ring 40.

Subsequently, the bed 103 is moved by the first transfer mechanism 104, and the second positioning platform 102 is set to the processing position. Note that, before the second positioning platform 102 is set to the processing position, the medium 10 is attached to the clamped portion 31 of the motor hub 30 assembled in the base 60.

Next, the heater head 105 is lowered by the second transfer mechanism 106, and the clamp ring 40 whose inner diameter has been expanded by heating from the heater head 105 is mounted on the supported portion 33 of the motor hub 30. Thereby, the clamped portion 32 of the motor hub 30 is inserted into the clamp ring 40.

Then, the attaching/detaching heads 107 are moved close to the shaft center of the spindle motor 20 by the third transfer mechanism 108. When the attaching/detaching pins 114 of the attaching/detaching heads 107 arrive at a specified position in the groove portions 113 of the heater head 105, the attaching/detaching heads 107 are lowered by the third transfer mechanism 108, so that the upper surface of the clamp ring 40 is pressed by the first pressing surfaces 115a of the attaching/detaching pins 114. At the same time when the pressing of the clamp ring 40 starts, the heater head 105 is moved upward by the second transfer mechanism 106.

Thereafter, the clamp ring 40 is cooled down to a room temperature. Then, the inner diameter of the hub pressing portions 41 of the clamp ring 40 becomes smaller. As a consequence, the clamp ring 40 is attached to the clamped portion 32 of the motor hub 30 by the shrink fitting method. In this manner, the medium 10 is fixed onto the support portion 33 of the motor hub 30.

[Method of Detaching Clamp Ring 40]

Next, explanation will be given to a method of detaching the clamping ring 40 in the case where the clamp ring 40 has been attached to the clamped portion 32 of the motor hub 30 by the shrink fitting method.

When, in the assembly of the magnetic disk device 1, the medium 10, the spindle motor 20, the motor hub 30, and the clamp ring 40 are assembled in the base 60, an evaluation experiment on functions and actions is carried out at that point.

If any failure is found in this evaluation experiment, the base 60 having the medium 10 and others assembled therein is transferred to the attaching/detaching device 100, so that the clamp ring 40 is detached.

When the clamp ring 40 is detached from the motor hub 30, the base 60 having the medium 10 and others assembled therein is first supplied onto the second positioning platform 102, wherein the base 60 is positioned.

Next, the bed 103 is moved by the first transfer mechanism 104, and the second positioning platform 102 is set to the processing position. At this moment, the attaching/detaching heads 107 have already been set so that the attaching/detaching pins 114 correspond to the empty spaces 43 between the outer circumferential surface of the motor hub 30 and the inner circumferential surface of the connecting portions 42 of the clamp ring 40.

Next, the attaching/detaching heads 107 are lowered by the third transfer mechanism 108, and the attaching/detaching pins 114 are inserted into the empty spaces 43 between the outer circumferential surface of the motor hub 30 and the inner circumferential surface of the connecting portions 42 of the clamp ring 40.

Then, the four attaching/detaching heads 107 are moved to the radial outer side of the clamp ring 40 at the same time, and the two portions displaced by the same distance to both the sides from the center in the concave portions 44 of the connecting portions 42 of the clamp ring 40 are pressed by the two second pressing surfaces 115b of the attaching/detaching pins 114, respectively.

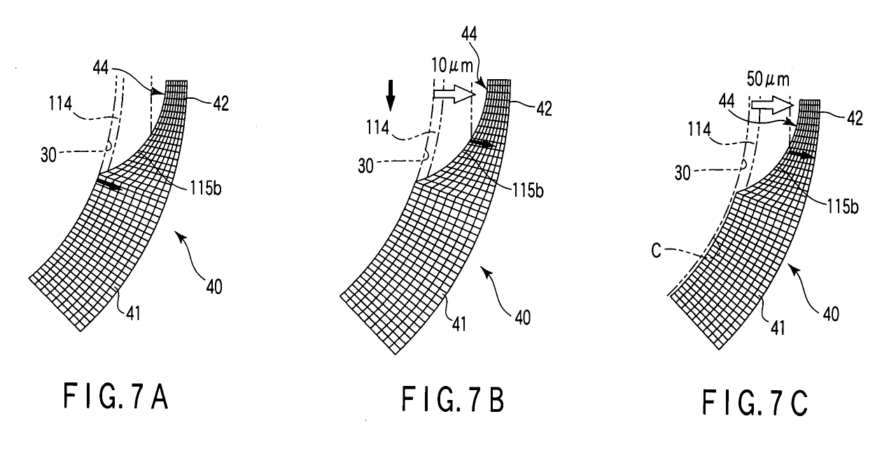

Thereby, the inner diameter of the hub pressing portions 41 of the clamp ring 40 expands, and there occurs an empty space C (illustrated in only FIG. 7C) between the outer circumferential surface of the motor hub 30 and the inner circumferential surface of the hub pressing portions 41. When the pushing amount of the connecting portions 42 by the attaching/detaching pins 114 becomes a predetermined value, the heater head 105 is lowered by the second transfer mechanism 106, and the clamp ring 40 is absorbed and held to the under surface of the heater head 105.

At the same time, the heater head 105 and the attaching/detaching heads 107 are moved upward by the second and third transfer mechanisms 106, 108, and the clamp ring 40 is pulled out from the clamped portion 32 of the motor hub 30. Through the above procedures, the removal of the clamp ring 40 is completed. Meanwhile, the detached clamp ring 40 is disposed.

What is important herein is that when the inner diameter of the hub pressing portions 41 of the clamp ring 40 is expanded, the two portions displaced by the same distance to both the sides from the center in the concave portions 44 of the connecting portions 42 are pressed by use of the attaching/detaching pins 114 according to the present embodiment. The other members, from which the clamp ring 40 has been removed, are subjected to a step of attaching new clamp ring 40 to them.

[Simulations]

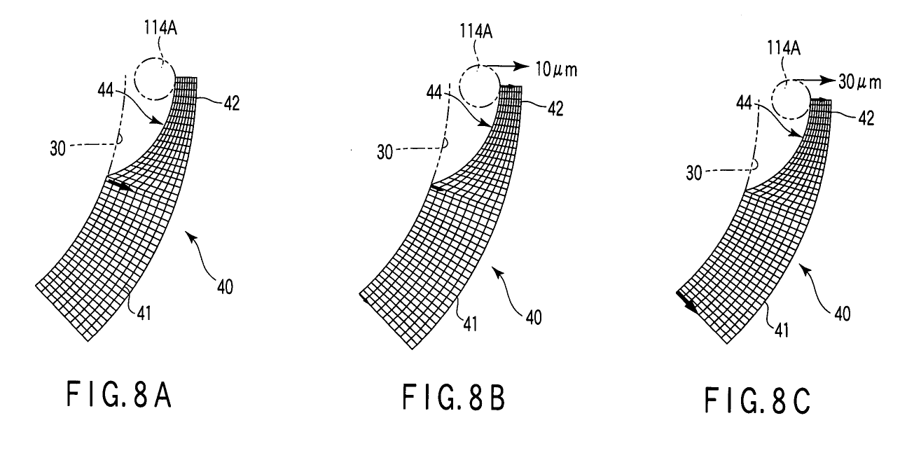

Next, the distribution of a pressure applied to the clamp ring 40 by using the attaching/detaching pins 114 according to the embodiment, and the distribution of a pressure applied to the clamp ring 40 by using cylindrical attaching/detaching pins 114A are examined by simulations. In FIGS. 7A to 7C and FIGS. 8A to 8C, portions wherein a pressure occurs are shown by arrows.

FIGS. 7B to 7C each are a view showing a stress applied to the clamp ring 40 when the clamp ring 40 is detached by use of the attaching/detaching pins 114 according to the first embodiment.

Before the attaching/detaching pins 114 contact the clamp pin 40, a pressure occurs at the both end portions (only one end portion illustrated) of the hub pressing portions 41 as shown by the arrow in FIG. 7A. This shows that the hub pressing portions 41 tighten up the motor hub 30.

When the connecting portions 42 are expanded by 10 μm to the radial outer side by means of the attaching/detaching pins 114, the pressure that occurred at the hub pressing portions 41 has disappeared as shown in FIG. 7B. This shows that the tightening of the motor hub 30 by the hub pressing portions 41 has been released.

It is known that when the connecting portions 42 are further expanded by 40 μm (50 μm from the initial state) to the radial outer side by means of the attaching/detaching pins 114, a 30-μm empty space C is formed between the outer circumferential surface of the motor hub 30 and the inner circumferential surface of the hub pressing portions 41, as shown in FIG. 7C. This shows that the clamp ring 40 is ready to be detached from the motor hub 30.

FIGS. 8A to 8C each are a view showing a stress applied to the clamp ring 40 when the clamp ring 40 is detached by use of cylindrical attaching/detaching pins 114A. As the attaching/detaching pins 114A, pins are used that have a sufficiently small radius of curvature in comparison with the radius of curvature of the inner circumferential surface of the connecting portions 42.

It is found that, before the attaching/detaching pins 114A contact the clamp pin 40, a pressure occurs at the both end portions (only one end portion illustrated) of the hub pressing portions 41 as shown by the arrow in FIG. 8A. This shows that the hub pressing portions 41 tighten up the motor hub 30.

It is found that, when the connecting portions 42 are expanded by 10 μm to the radial outer side by means of the attaching/detaching pins 114A, the pressure that has been applied to both the end portions of the hub pressing portions 41 decreases, and another pressure occurs at the central portion of the hub pressing portions 41, as shown in FIG. 8B. This shows that the tightening of the motor hub 30 by the hub pressing portions 41 is still not released.

It is known that, when the connecting portions 42 are further expanded by 20 μm (30 μm from the initial state) to the radial outer side by means of the attaching/detaching pins 114A, the pressure applied to the central portion of the hub pressing portions 41 increases as shown in FIG. 8C. This shows that the tightening of the motor hub 30 by the hub pressing portions 41 increases.

From the simulations in FIGS. 7A to 7C and FIGS. 8A to 8C, it has been apparent that, when the attaching/detaching pins 114 according to the embodiment are used, in other words, when the two portions away by the same distance to both the sides from the center in the inner circumferential surface of the connecting portions 42 are pressed at the same time, the empty space C is formed between the outer circumferential surface of the motor hub 30 and the inner circumferential surface of the hub pressing portions 41 with a small pushing amount.

(Operation by Present Embodiment)

According to the method of detaching the clamp ring 40, the attaching/detaching pins 114 of the clamp ring 40, and the method of manufacturing the magnetic disk device 1, the two portions away by the same distance to both the sides from the center in the inner circumferential surface of the concave portions 44 of the connecting portions 42 are pressed when the clamp ring 40 is detached from the motor hub 30. When these two portions are pressed, the connecting portions 42 are expanded in the circumferential direction, and the circumferential length of the clamp ring 40 is expanded.

Because the empty space C is formed between the outer circumferential surface of the motor hub 30 and the inner circumferential surface of the hub pressing portions 41 with a small pushing amount, the removal work of the clamp ring 40 is simplified, and the time required for detaching the clamp ring 40 is shortened.

In the present embodiment, the attachment and detachment of the clamp ring 40 is carried out by the single attaching/detaching device 100, but it may be carried out by separate devices. When the attachment and detachment of the clamp ring 40 is carried out by separate devices, there is no need to stop an assembly line, which makes it possible to increase the efficiency of assembly.

As a device for attaching the clamp ring 40, a magnetic disk device assembly device described in Japanese Patent Application No. 2004-247618 may be employed.

In the present embodiment, the center of the concave portions 44 of the connecting portions 42 is in the plan view of the clamp ring 40.

(Second Embodiment)

Next, a second embodiment will be explained hereinafter. Herein, with regard to the same configuration and function as those in the first embodiment, explanations thereof are omitted.

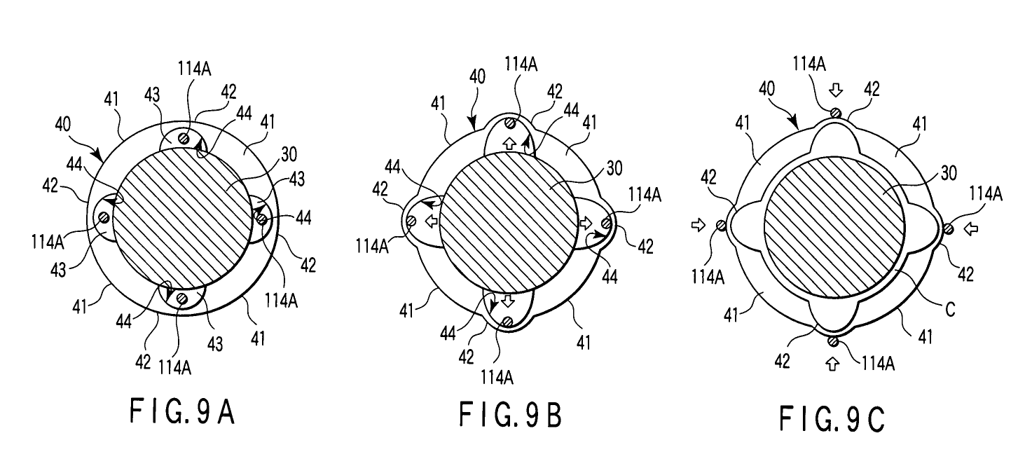

FIGS. 9A to 9C each are a process chart in case of detaching the clamp ring 40 by a detaching method according to the second embodiment of the present invention.

[Method of Detaching Clamp Ring 40]

When the clamp ring 40 is to be detached from the motor hub 30, the cylindrical attaching/detaching pins 114A are first inserted into the respective empty spaces 43 between the motor hub 30 and the connecting portions 42, as shown in FIG. 9A.

Next, as shown in FIG. 9B, the inner circumferential surface of the concave portions 44 of the connecting portions 42 is pressed in the arrow direction by the attaching/detaching pins 114A. Thereby, the connecting portions 42 that are thin in the clamp ring 40 are expanded in the circumferential direction by plastic deformation, so that the circumferential length of the clamp ring 40 is expanded.

Subsequently, as shown in FIG. 9C, the outer circumferential surface of the connecting portions 42 is pressed in the arrow direction by the attaching/detaching pins 114A, and the clamp ring 40 is formed so as to become substantially circular. As a consequence, the empty space C is formed between the outer circumferential surface of the motor hub 30 and the inner circumferential surface of the hub pressing portions 41, and the clamp ring 40 is ready to be detached from the motor hub 30.

Even when the method of the present embodiment is used, the clamp ring 40 attached to the motor hub 30 by the shrink fitting method can be detached easily, and consequently, the time required for detaching the clamp ring 40 is shortened.

(Third Embodiment)

Next, a third embodiment will be explained hereinafter. Herein, with regard to the same configuration and function as those in the first embodiment, explanations thereof are omitted.

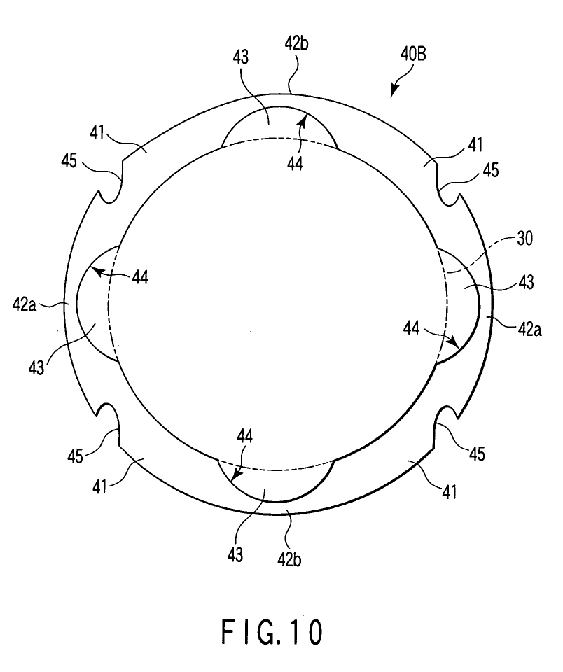

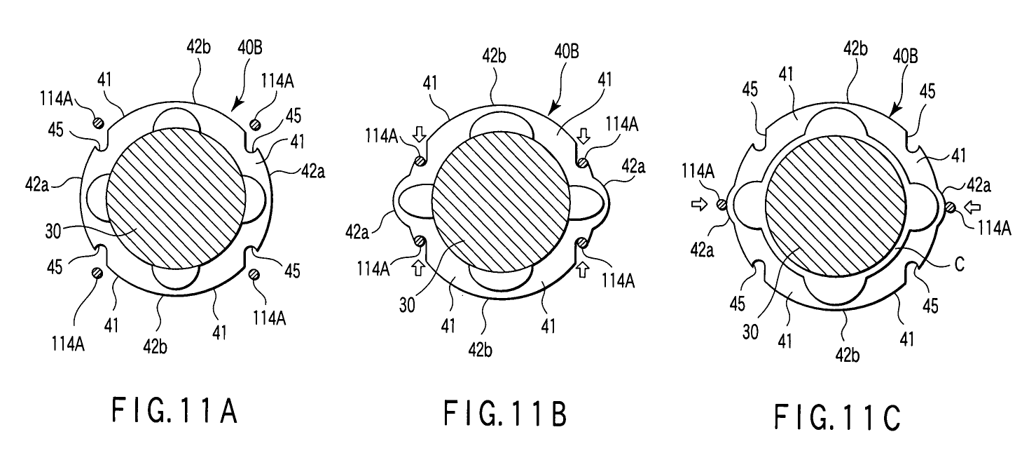

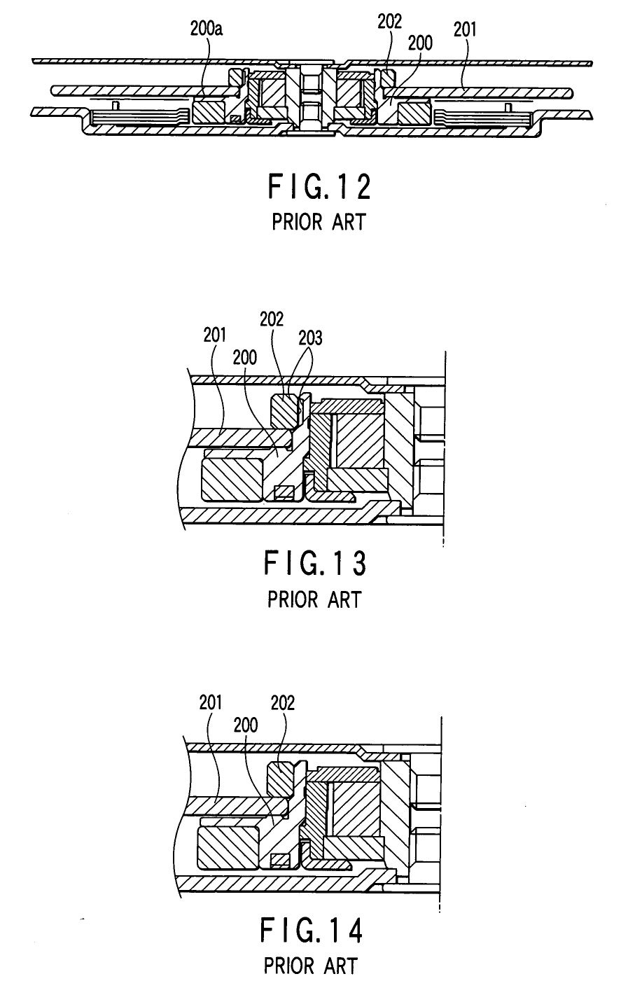

FIG. 10 is a plan view of a clamp ring 40B according to the third embodiment of the present invention, and FIGS. 11A to 11C each are a process chart in case of detaching the clamp ring 40B by a detaching method according to the third embodiment.

[Configuration of Clamp Ring 40B]

As shown in FIG. 10, the clamp ring 40B according to the embodiment includes notch portions 45 for respectively engaging with the attaching/detaching pins 114A, in the outer circumferential surface of the hub pressing portions 41 according to the above embodiment. These notch portions 45 are arranged to be adjacent to two opposing connecting portions 42a, 42a.

[Method of Detaching Clamp Ring 40B]

When the clamp ring 40B is to be detached from the motor hub 30, the attaching/detaching pins 114A are first engaged respectively to the notch portions 45 formed in the respective hub pressing portions 41 of the clamp ring 40B, as shown in FIG. 11A.

Next, as shown in FIG. 11B, the notch portions 45 are pressed in the arrow direction by the attaching/detaching pins 114A. Then, the connecting portions 42a, 42a that are near the notch portions 45 deform, and the central portions thereof protrude in the direction going away from the outer circumferential surface of the motor hub 30. Thereby, the two connecting portions 42b, 42b that are away from the notch portions 45 are expanded in the circumferential direction, so that the circumferential length of the clamp ring 40B is expanded.

Subsequently, as shown in FIG. 1C, the outer circumferential surfaces of the connecting portions 42a, 42a protruding in the direction going away from the outer circumferential surface of the motor hub 30 are pressed by the respective attaching/detaching pins 114A in the arrow direction, i.e., to the radial inner side of the clamp ring 40B, and the clamp ring 40B is formed so as to become substantially circular. Thereby, the empty space C is formed between the outer circumferential surface of the motor hub 30 and the inner circumferential surface of the hub pressing portions 41, and the clamp ring 40 is ready to be detached from the motor hub 30.

Even when the method of the present embodiment is used, the clamp ring 40 attached to the motor hub 30 by the shrink fitting method can be detached easily, and consequently, the time required for detaching the clamp ring 40 is shortened.

Note that the method of expanding the connecting portions in the circumferential direction is not limited to the second and third embodiments, but any other method may be employed.

The present invention is not limited to the above embodiments, but the present invention may be embodied by appropriately modifying the constituent elements thereof without departing from the spirit or essential characteristics thereof. It is also possible to extract various stages of invention by appropriate combinations of plural constituent elements disclosed in each of the embodiments. For example, some constituent elements may be deleted from all the elements shown in the embodiments. Furthermore, the constituent elements of different embodiments may be appropriately combined.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A clamp ring detaching method of detaching from a motor hub a clamp ring fastened to the motor hub, the clamp ring comprising a plurality of hub pressing portions contacting the outer circumferential surface of the motor hub and connecting portions which connect the hub pressing portions, each connecting portion having a concave portion, the method comprising:
pressing portions of at least one of the concave portions, which are displaced from a center of the concave portion, outwards in a radial direction of the clamp ring in order to remove the clamp ring from the motor hub.

2. A clamp ring detaching method of detaching from a motor hub a clamp ring fastened to the motor hub, the clamp ring comprising a plurality of hub pressing portions contacting the outer circumferential surface of the motor hub and connecting portions which connect the hub pressing portions, each connecting portion having a concave portion, the method comprising:
expanding the connecting portions plastically outwards in a radial direction of the clamp ring in order to remove the clamp ring from the motor hub; and
pressing the outer circumferential surface of the connecting portions expanded, inwards in a radial direction of the clamp ring.

3. A clamp ring detaching method according to claim 2, wherein
the inner circumferential surface of the connecting portions is pressed outwards in a direction of the clamp ring, and the connecting portions are expanded plastically.

4. A clamp ring detaching method according to claim 2, wherein
at least a pair of hub pressing portions connected by an arbitrary connecting portion possessed by the clamp ring is pressed in a direction to move close to each other, and the remaining connecting portions possessed by the clamp ring are expanded plastically.

5. A method of detaching from a motor hub a clamp ring in which a plurality of hub pressing portions contacting the outer circumferential surface of the motor hub and connecting portions which connect the hub pressing portions, each connecting portion having a concave portion are arranged alternately, the method comprising:
pressing portions at least one of the concave portions, which are displaced to both the sides from a center of the concave portion, outwards in a direction of the clamp ring at the same time in order to remove the clamp ring from the motor hub.

6. A clamp ring detaching method according to claim 1, wherein
a distance from a center of the clamp ring to the concave portions is greater than a distance from the center of the clamp ring to the inner circumferential surface of the hub pressing portions.

7. A clamp ring detaching method according to claim 2, wherein
a distance from a center of the clamp ring to the concave portions is greater than a distance from the center of the clamp ring to the inner circumferential surface of the hub pressing portions.

8. A clamp ring detaching method according to claim 5, wherein
a distance from a center of the clamp ring to the concave portions is greater than a distance from the center of the clamp ring to the inner circumferential surface of the hub pressing portions.

9. A clamp ring detaching tool to be used when detaching from a motor hub a clamp ring fastened to the motor hub, the clamp ring comprising a plurality of hub pressing portions contacting the outer circumferential surface of the motor hub and connecting portions which connect the hub pressing portions, each connecting portion having a concave portion, the tool comprising:
a pressing portion which presses those portions of at least one of the concave portions which are displaced from a center of the concave portion, at the same time outwards in a radial direction of the clamp ring.

10. A clamp ring detaching tool according to claim 9, wherein
the pressing portion is including a plurality of pressing surfaces.

11. A clamp ring detaching tool according to claim 10, wherein
at least one of the pressing surfaces has substantially the same radius of curvature as that of the concave portions.

12. A clamp ring detaching tool according to claim 9, wherein
the pressing portion is including pressing surfaces formed in both the sides of the center of the concave portions.

13. A clamp ring detaching tool according to claim 12, wherein
at least one of the pressing surfaces has substantially the same radius of curvature as that of the concave portions.

14. A clamp ring detaching tool according to claim 10, wherein
a cross-sectional shape orthogonal to the pressing surfaces is substantially trapezoidal.

15. A clamp ring detaching tool according to claim 12, wherein
a cross-sectional shape orthogonal to the pressing surfaces is substantially trapezoidal.

16. A clamp ring detaching tool according to claim 10, further comprising:
a surface which has a larger radius of curvature than that of the pressing surfaces and connects the pressing surfaces.

17. A clamp ring detaching tool according to claim 12, further comprising:
a surface which has a larger radius of curvature than that of the pressing surfaces and connects the pressing surfaces.

18. A clamp ring detaching tool according to claim 16, wherein
the pressing surfaces and the surface are arranged alternately.

19. A clamp ring detaching tool according to claim 17, wherein
the pressing surfaces and the surface are arranged alternately.

20. A method of manufacturing a magnetic disk device, having detaching from a motor hub a clamp ring fastened to the motor hub, the clamp ring comprising a plurality of hub pressing portions contacting the outer circumferential surface of the motor hub and connecting portions which connect the hub pressing portions, each connecting portion having a concave portion, the detaching comprising:
pressing portions of at least one of the concave portions, which are displaced from a center of the concave portion, outwards in a radial direction of the clamp ring in order to remove the clamp ring from the motor hub.
